(19) United States
(12) Patent Application Publication
(10) Pub. No.: US 2020/0226631 A1
(43) Pub. Date: Jul. 16, 2020

(54) SYSTEMS, METHODS, AND COMPUTER READABLE MEDIUMFOR SHORT MESSAGE COMMUNICATION

(71) Applicant: FaceFirst, Inc., Encino, CA (US)

(72) Inventors: Roger Angarita, Encino, CA (US); Peter Trepp, Encino, CA (US)

(21) Appl. No.: 16/740,356

(22) Filed: Jan. 10, 2020

Related U.S. Application Data
(60) Provisional application No. 62/791,719, filed on Jan. 11, 2019.

(51) Int. Cl. G06Q 30/02; H04W 4/021; G06K 9/00; H04L 12/58

(52) U.S. Cl. CPC G06Q 30/0224; G06Q 30/0212; H04L 51/20; G06K 9/00771; G06K 9/00288; H04W 4/021

(57) ABSTRACT

A computer implemented system for automatically identifying an individual in an environment and automatically sending customized short messages to the identified individual. An image of an individual is received through a camera installed on a premise of a partner that uses the present system. The present system stores identification information of the individual, such as an image of the individual, and other information about the individual that the individual previously provided. The present system determines whether the received image matches the stored identification information. When they match, the present system customizes a short message using the stored identification information and other information about the individual and transmits the customized short message to a mobile phone of the identified individual over a carrier network. Counterpart computer implemented method and computer readable medium embodiments are also contemplated.

### CROSS-REFERENCE TO RELATED APPLICATION(S)

This application claims the benefit of U.S. Provisional Application 62/791,719, filed Jan. 11, 2019, the entirety of which is herein incorporated by reference.

### FIELD OF THE INVENTION

The present application relates to new and innovative techniques for automatically identifying an individual in an environment and automatically sending customized short messages to the identified individual.

### BACKGROUND OF THE INVENTION

In a large environment such as in a building where there is numerous people (e.g., on the scale 100 or more, or 1000 or more), it is difficult if not impossible to remember everyone's name, telephone number, what they look like, their preferences, and other information. Without the correct information or such information, a person, entity, or computer system that wants to communicate specific messages to certain individuals or their mobile devices in real-time cannot effectively relay such messages. A message tailored to one person may be transmitted to another person who does not want to receive the message or would prefer to receive a different kind of message (referring to message transmission to their mobile device). A message might be sent to the right person but the message lacks the key information that the sender wants to convey or the recipient wants to receive, or is not personalized to the recipient. The recipient of a message may want to personalize the messages they receive even further, making pre-defined choices about the types of messages they receive from a sender based on their preferences. The sender, in turn, might want to send specific key information and messages to the recipient and provide the sender choices about the types of messages the recipient could receive. These problems become worse when there are multiple such environments or as the number of people in the same environment increases.

Currently, there is no known technology that can effectively and quickly identify an individual in an environment, send customized messages to the identified individual, and allow enrollment of individuals who want to receive customized messages from a particular party.

### SUMMARY OF THE INVENTION

In accordance with principles of the invention, a computer-implemented method for messaging communication is contemplated. The method comprises implementing a program application for an entity allowing the entity to create a program. Through the program, the entity can receive identification information and other personal information of one or more individuals and transmit customized messages to the individuals when the individuals are on a physical premise of the entity. The method also comprises receiving identification information and other personal information of one or more persons through the implemented program application. The identification information includes facial identification information of each person and a telephone number of each person associated with a mobile device. The identification information and other personal information are provided by the persons specifically for the program to receive customized messages from the entity when they are on a physical premise of the entity. The method further comprises receiving one or more frames from video cameras positioned in physical premises of the entity. Additionally, the method comprises applying a facial recognition process to the received frames based on a database storing the facial identification information of the individuals in the program. The step of applying determines that a person in the program is currently in one of the physical premises of the entity and identifies the person. The method also comprises generating a customized message using the received other personal information for the identified person. The method further comprises transmitting the customized message to a mobile phone of the identified person over one or more mobile cellular wireless telecommunications network using the telephone number received for the program. The customized message is received by the identified person while he is on the premise of the entity.

In one embodiment, the customized message is transmitted to the mobile phone of the identified person within 1-5 seconds after receiving the one or more frames from the video cameras.

In one embodiment, the method further comprises generating and transmitting additional messages in response to the identified person responding to the transmitted customized message.

In one embodiment, the transmitted customized message or additional messages includes a coupon code that can be redeemed at a cash register of the physical premise of the entity.

In one embodiment, the method further comprises retrieving content from a database of marketing materials or a system that is configured to generate marking content based on information in the program or received identification information and other personal information that provide context such as a shopping history of the person with the entity.

In one embodiment, the method further comprises instructing a separate third party system to generate and transmit the customized message to the mobile phone of identified person.

In one embodiment, the method further comprises communicating with an enterprise system of the entity and a short message service provider system to initiate the transmission of the customized message.

In one embodiment, the method further comprises communicating with an enterprise system of the entity and a short message service provider system to coordinate the two systems to cause the transmission of the customized message.

In one embodiment, the method further comprises generating and transmitting other information about the identified person to a mobile device used by an employee of the entity.

In one embodiment, the step of receiving one or more frames from video cameras positioned in physical premises of the entity include receiving one or more frames from surveillance security cameras positioned in physical premises of the entity.

In one embodiment, the method further comprises determining that the identified person made a purchase online for in-store pickup and the step of transmitting the customized message includes transmitting a customized message asking the identified person to confirm that he is on the premise for in-store pickup.

In one embodiment, the method further comprises generating and transmitting other information about the identified person made a purchase online for in-store pickup to a mobile device used by an employee of the entity.

In one embodiment, the other personal information the identified person provided for the program includes payment method information and the step of transmitting the customized message includes transmitting a customized message asking the identified person whether a transaction on the premise should be processed using the payment method information. The method further comprises transmitting another customized message including a receipt of the transaction.

In one embodiment, the method further comprises transmitting the received frames to a data center implementing a facial recognition process that is remote from the physical premises in which the video cameras are positioned and the step of applying a facial recognition process is performed at the data center.

In one embodiment, the method further comprises receiving a response to the transmitted customized message from the mobile phone of the identified person over the mobile cellular wireless telecommunications network.

In one embodiment, the facial identification information includes an image of each person. The method further comprises receiving the image from a mobile device of that person.

In accordance with principles of the invention, a non-transitory computer readable medium for messaging communication is contemplated. The medium stores computer-executable instructions and, once executed by a computer system, cause the computer system to execute a method. The method comprises implementing a program application for an entity allowing the entity to create a program. Through the program, the entity can receive identification information and other personal information of one or more individuals and transmit customized messages to the individuals when the individuals are on a physical premise of the entity. The method also comprises receiving identification information and other personal information of one or more persons through the implemented program application. The identification information includes facial identification information of each person and a telephone number of each person associated with a mobile device. The identification information and other personal information are provided by the persons specifically for the program to receive customized messages from the entity when they are on a physical premise of the entity. The method further comprises receiving one or more frames from video cameras positioned in physical premises of the entity. Additionally, the method comprises applying a facial recognition process to the received frames based on a database storing the facial identification information of the individuals in the program. The step of applying determines that a person in the program is currently in one of the physical premises of the entity and identifies the person. The method also comprises generating a customized message using the received other personal information for the identified person. The method further comprises transmitting the customized message to a mobile phone of the identified person over one or more mobile cellular wireless telecommunications network using the telephone number received for the program. The customized message is received by the identified person while he is on the premise of the entity.

In accordance with principles of the invention, a computer-implemented system for messaging communication is contemplated. The system comprises a feature system including a processor and memory that stores computer-executable instructions. When the instructions are executed by processor, the execution causes the processor to implement a program application that is configured to allow an entity to create a program. Through the program, the entity can receive identification information and other personal information of one or more individuals and transmit customized messages to the individuals when the individuals are on a physical premise of the entity. The execution also causes the processor to receive identification information and other personal information of one or more persons through the implemented program application. The identification information includes facial identification information of each person and a telephone number of each person associated with a mobile device. The identification information and other personal information are provided by the persons specifically for the program to receive customized messages from the entity when they are on a physical premise of the entity. The execution further causes the processor to receive one or more frames from video cameras positioned in physical premises of the entity. Additionally, the execution further causes the processor to apply a facial recognition process to the received frames based on a database storing the facial identification information of the individuals in the program. The step of applying determines that a person in the program is currently in one of the physical premises of the entity and identifies the person. The execution also causes the processor to generate a customized message using the received other personal information for the identified person. The execution further causes the processor to communicate with a message service provider system to transmit the generated customized message. Additionally, the execution causes the processor to transmit the customized message using the message service provider system to a mobile phone of the identified person over one or more mobile cellular wireless telecommunications network. The step of transmitting uses the telephone number received for the program to transmit the customized message. The customized message is received by the identified person while he is on the premise of the entity.

### BRIEF DESCRIPTION OF THE DRAWINGS

Various features of examples in accordance with the principles described herein may be more readily understood with reference to the following detailed description taken in conjunction with the accompanying drawings, where like reference numerals designate like structural elements, and in which:

FIG. 1 depicts illustrative feature system, client system, and short message service provider system configured to communicate over a network and other features in accordance with some embodiments of the present invention;

FIG. 2a depicts an illustrative short message received by an identified or enrolled individual on a premise of a partner in accordance with some embodiments of the present invention;

FIG. 2b depicts illustrative other information about an identified or enrolled individual on a premise of a partner in accordance with some embodiments of the present invention;

FIG. 3 depicts an illustrative facial recognition system or application implemented as cloud service using one or more data centers in accordance with some embodiments of the present invention;

FIG. 4 depicts an illustrative application of the systems shown in FIG. 1 to in-store pick up scenario in accordance with some embodiments of the present invention; and

FIG. 5 depicts an illustrative application of the systems shown in FIG. 1 to in-store payment scenario in accordance with some embodiments of the present invention.

### DETAILED DESCRIPTION OF THE INVENTION

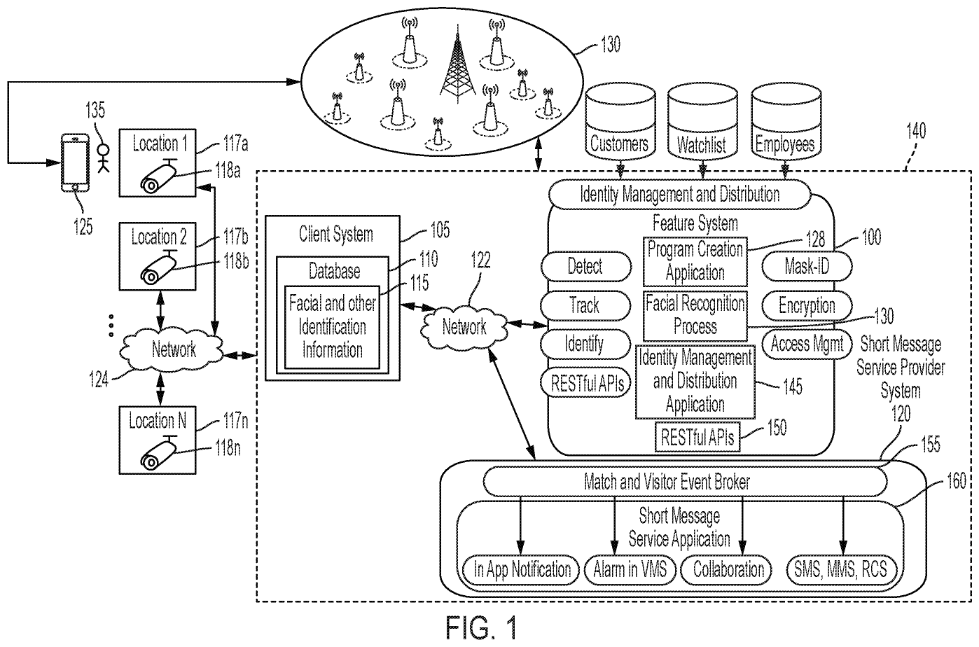

FIG. 1 depicts illustrative systems implementing short message communication. Embodiments of the present invention involve a feature system 100, a client system 105, and a short message service provider system 120 configured to communicate over a network 122. The feature system 100 includes software and/or hardware implementing a facial recognition application 130, an identity management and distribution application 145, RESTed APIs 150, and a program creation application 128. The feature system 100 may be configured to communicate with databases or computer systems storing client information, watchlist information, and partner's employee information. The client system or partner system 105 includes software and/or hardware implementing a database storing facial identification information and other identification information. The client system 105 is configured to communicate with a video camera 118a-118n installed at a premise or location 117a-117n of the client or partner. The client system 105 may also be configured to communicate with a computer system at the location that communicates with the camera. The camera or the computer system with which the camera communicates are configured to transmit images, frames, or video of individuals at the location to the client system 105 or the feature system 100. The short message service provider or vendor system 120 includes software and/or hardware implementing a match and visitor event broker application 155 and a short message service application 160. One or more of the feature system 100, client system 105, and vendor system 120 (system 140) are configured to send a short message to a mobile phone 125 of an individual 135 (at one of the partner's locations) that is identified or recognized by the feature system 100. The feature system 100 can perform the recognition process based on the received images, frames, or video and the facial identification information 115. Counterpart implemented methods and computer readable embodiments are understood from this and other figures and the description below.

A retailer or other entity having one or more physical store locations can improve interactions by implementing new customer communications arrangements. In general, an entity that has one or more physical store locations for allowing customers to shop for products on their physical premises and to make purchases is referred to as a partner or merchant. The feature system 100 is configured that works in cooperation with computer systems of a partner including databases of the partner to communicate messages to individuals or customers on the physical premises of the partner. The messages are preferably Short Message Service (SMS) messages, Multimedia Message Service (MMS) messages, or Rich Communications Service messages which are generally referred to as short messages, in this document. Partner and partner system are shown as client and client system in the figures of this application. The feature system 100 is configured to allow the partner to enroll an individual in a program in which the individual voluntarily provides facial identification information (such as an image of his or her face) to the partner. The partner saves the facial identification information 115 in their computer systems 105 (such a database 110) along with other information such information that specifies that the individual has enrolled in this specific program. Other information can be a telephone number of the individual, a profile of the individual, the shopping history of the individual, or other personal information (related to demographics, preferences, or shopping habits). The telephone number may be a mobile telephone number (carrier-supplied mobile phone number) or telephone service application number (e.g., Google Voice-provided telephone number). In some embodiments, the telephone number may be a landline phone number (messages may be displayed in the screen where the caller ID is displayed). The facial identification information and the other information may be accessible or transmitted to the feature system 100. The facial identification information and the other information may be collectively referred to as customer identification information 115. The program allows the enrolled individual to receive coupons or discounts on the products and services sold by the partner that creates the program. The partner can create and enroll customers in such a program through the feature system 100 or through the program creation and enrollment application 128. The feature system 100 may also be referred to as a promotion program creation and enrollment system.

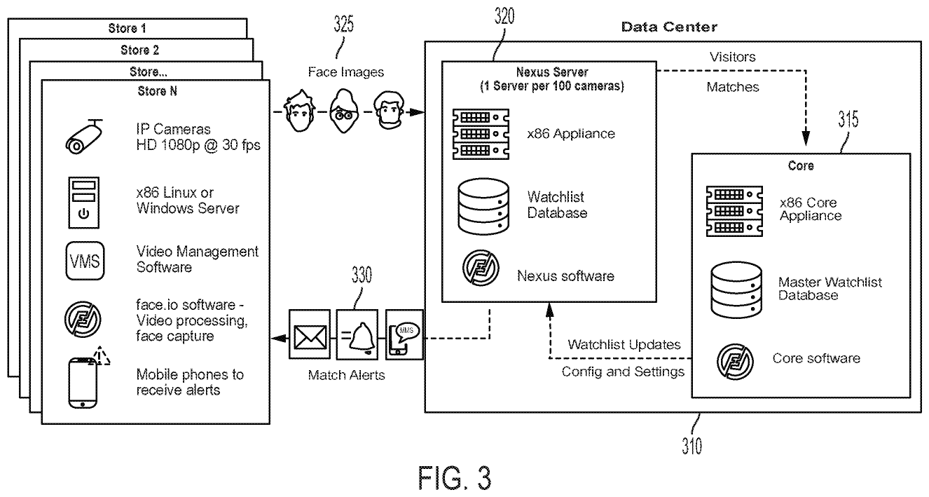

Individual physical store locations 117a-117n of the partner can have one or more video cameras 118a-118n on the physical premises positioned to view the individuals (and their faces) while they are on the physical premises 117a-117n such as when they are browsing through the store or when they first enter the store. The feature system 100 is configured to receive contents such as images or video from these cameras 118a-118n (either directly or through the partner system 105). The feature system 100 is configured to apply the received content to the facial identification information for the customers of partner X who enrolled in the program. The feature system 100 is configured to implement a facial recognition process 130 using techniques such as those described in U.S. Pat. No. 9,141,863, titled Managed Biometric-Based Notification System & Method, filed on Jul. 21, 2008, and U.S. Pat. No. 9,245,190, titled Biometric Notification System, filed on Feb. 3, 2015, which are incorporated by reference in their entirety. The facial recognition process 130 may determine if the person (or the face of the person) matches one of the images in the facial identification information. If there is a match, then the feature system 100 determines that the person on the premise is enrolled in the program. If there is no match, then the feature system 100 determines that the person on the premise is not enrolled in the program. If an image, frame, or video contains faces of more than one person (e.g., when multiple people walk through the view of the camera), the feature system 100 can make determinations for each face. The feature system 100 then transmits customized short messages (discussed below) to mobile phones of matched individuals in response to the determinations. The feature system may not transmit a message or may transmit a different type of message (e.g., a general message that is applicable to everyone without considering their personal information such as shopping information and other information) to mobile phones of individuals who do not have a match. Such general-type message transmission may occur over a carrier network, a local network (e.g., WiFi), or both. The feature system 100 such as a portion that performs the process of determining whether an enrolled individual is currently on the premise of a partner is preferably performed remotely from the premise such as at a cloud service implemented in a data center. FIG. 3 depicts such a system and is further described below. The facial identification information can be provided to the system that is performing this service and the facial identification information is stored as part of this system.

The feature system 100 can, in response to receiving the content, determine that one or more enrolled individuals are currently in a store and can determine an identity of that individual (e.g., their actual name or some other identifier) using the facial recognition process 130. The feature system 100 may also retrieve, determine, or store other information such as profiles for individuals, contact information (a telephone number of the individual, a messaging address for short message messaging, etc.).

The facial recognition process 130 can be implemented as an application using software and/or hardware. In one embodiment, the facial recognition application 130 is configured to use facial identification information and video images (which is to be understood to include derivatives from which facial recognition can take place) such as from retail stores and in real-time (or in a reasonable short amount of time to when the image is taken such as preferably 1-5 seconds but can be longer such as 20 minutes) determine whether an individual enrolled in a program with a partner (there can be multiple partners relying on the feature system 100) is currently at a corresponding partner location. The customized short message is also generated and transmitted to the identified individual in real-time (can receive the message in 1-5 seconds but can be longer such as 20 minutes). The individual can receive the customized short message while he is on the premise.

When an individual is identified, the feature system 100 uses application program interfaces (APIs) 150 to interact with the partner system 105 and the vendor system 120. The partner system 105 can, for example, include a computer system such as an enterprise computer network and system of a company (e.g., a retailer that has physical store locations). There may be multiple partner systems 105 with each representing a different partner (e.g., partner system A belongs to McDonald's, partner system B belongs to Walmart's, etc.). In some embodiments, a single partner system may also be implemented to include information or databases from different partners. The partner system 105 can include a partner database 110 and related services such as CRM, loyalty, or customer profile database. The partner system 110 can include data and related process that are used to customize and prepare content in response to the feature system 100 communicate with APIs that an individual enrolled in that partner's program is currently on their store premises. The communication can involve bi-directional communications.

The feature system 100 is configured to use the determination or identification that an individual 135 is currently present in the store to communicate with the individual 135 using a short message transmitted over a mobile cellular wireless telecommunication network 130 to the individual's mobile phone 125. A mobile cellular wireless telecommunication networks is the communications network, involving many distributed base stations (and related infrastructure), that individual mobile phones subscribe to use (as their provider or carrier network such as AT&T, Verizon Wireless, or T-Mobile) to receive wireless telecommunications services including telephone and short messages over a wide geographic area using wireless telecommunications standards such as GSM and CDMA. For simplicity, a mobile cellular wireless telecommunication network is referred to as the carrier network. Mobile phones are configured to communicate with carrier networks and wireless local area networks such as WiFi and Bluetooth. Other mobile devices can also be used such as tablets, personal digital assistant (PDA), or other electronic devices that can be configured to have a phone number (e.g., provided by a telecommunication carrier, a telephone service or app such as Google Voice, etc.). Transmission of a short message to or from a mobile phone or a system in FIG. 1 involves at least the carrier network. The short message may be transmitted to or from a mobile phone or a system directly (relies on the carrier network only) or indirectly (relies on a WiFi connection first if it is available then the carrier network, or the carrier network first and then a WiFi connection).

The feature system 100 is configured to transmit a short message over a carrier network 130 to individuals' mobile phones 125. This can include or be limited to being configured to initiate or trigger another system (e.g., short message service provider or vendor system 120) to transmit the short message. This can be a cooperative arrangement involving the computers or databases that store information and processes of one or more partners and vendor systems 140 that receive content, trigger or initiate the short message, generate the short message using the content, and transmit the short message over the carrier network 130. It can also include or involve a back and forth reply text or other type of message exchange involving the systems 140 of a partner and vendor (and can involve the feature system directly, e.g., carries messages, or indirectly) in connection with interacting with a customer that is identified and being marketed by way of messages at the store. The short messaging can therefore involve a sequence of short messages such as when a customer is communicating back and forth (responsive to an initial message) and the system(s) 140 are, for example, generating or creating new messages that are customized for that individual. A short message may support up to a maximum number of characters such as 160 or 250 characters and the ability to send multi-media content like images, gifs, and videos. If a system in FIG. 1 or an individual types and sends a short message containing more than the maximum allowed characters, then the composed message is sent in two or more messages. Other maximum numbers of characters are also possible depending on the carrier, mobile device, and/or the system used.

The content for the message can be prepared by the feature system 100 or information can be provided by the feature system 100 to a computer system 105 of the partner to access information about that individual from the database 110 maintained by the partner and use that information to select or prepare content to be used for the short message. The information provided by the feature system 100 to the partner system 105 may include the individual's identity information (e.g., their actual name or some other identifier), image matching result, or other information obtained after performing the facial recognition process 130. This information allows the partner system to access other information of the individual in the database of the partner system such as the profile of the individual, the shopping history of the individual, contact information (e.g., a telephone number of the individual to receive short messages or discounts, a messaging address for short message messaging, etc.), or other personal information (e.g., related to demographics, preferences, or shopping habits, payment method, shipment address).

The content can be prepared or selected using a process that is preferably context sensitive based on the information stored by the partner about that individual or other information that can customize the message. The content can be prepared or selected by the feature system 100, partner system 105, or both. A short message containing the content (or a portion thereof) is transmitted to the identified customer's mobile phone over the carrier network. The message can be transmitted by a vendor system 120 that is configured to provide such communications.

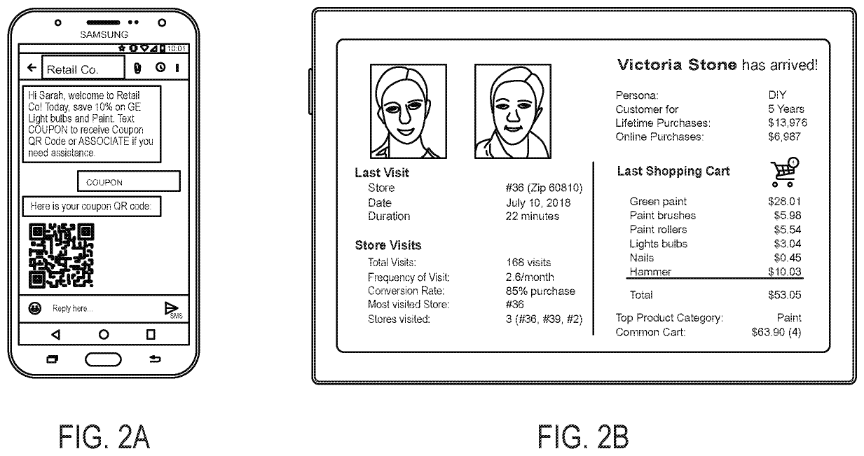

For example, with reference to FIG. 2a, when an enrolled customer is identified to be currently in a store, using a real time process that identifies that individual, the feature system is configured to send or cause to send a short message adapted for that individual. The short message is sent to the mobile phone of that individual using their telephone number or address (IP address, MAC address, etc.) provided during enrollment. The message is prepared to be customized for that individual. In this case, a short message is sent comprising content that informs the individual that they can receive a discount on certain products today. As shown, the individual can respond with a message (specified for the user) to receive additional content such as a QR code for a discount mentioned in the earlier message. The feature system can be configured to send or cause to send multiple short messages adapted for the individual without requiring the individual responding to one of the sent messages. The individual can respond to one or more of the sent messages to receive the corresponding coupons.

The QR code can then be used at the cash register for the discount when the individual checks out at the cash register at the store. The short message is configured to identify the sender or partner, the item or service for which the individual is receiving discount, the amount of discount (e.g., a percentage or a monetary amount like $5), such as by having message-identification information specifying the name of the store, the item or service, and, the amount of discount, or a combination thereof. The vendor system 120 can be responsible for transmitting (and receiving) the short messages and the vendor system 120 can be initiated or triggered to do so by receiving a communication for or a communication from the feature system 100. The vendor system 120, feature system 100, and partner system 105 can be separate and distinct systems owned by different entities and operating under different network domains. The partner system 105 and feature system 100 can operate cooperatively to produce targeted messages that are transmitted by the vendor system 120. The partner system 105 can be configured to provide specialized content such as the QR code or other discount-providing content such as an alphanumeric code or URL link that is produced by the partner system 105 to authorize the offer or discount to the desired recipient of the message. In some embodiments, the specialized content may include a user selectable code or link that, upon selection, causes the mobile phone to initiate a browser app on the mobile phone and loads a web page of the partner's website containing the actual discount content that may be redeemed at a checkout system of the partner. The code or link, upon selection, may also cause the mobile phone to initiate a partner app (or partner's mobile application) on the mobile phone and presents a page in the partner app containing the actual discount content that may be redeemed at a checkout system of the partner. The discount content is only available through the code or link and is generated specific to that individual (e.g., the person likes Wise potato chips and the discount content is for Wise potato chips products). In some embodiments, each generated discount content is unique and the generated discount contents (or the associated code or link) do not repeat. In some embodiments, the same generated discount content (or the associated code or link) can send to multiple different individuals. The code or link may also be presented in the form of a notification or included in a notification that is generated by the mobile phone, such as a notification icon that appears in the notification bar that is on top of the mobile phone or that appears on the lock screen or notification screen of the mobile phone (e.g., the initial screen that shows up after clicking a button of the mobile phone to turn on the screen of the mobile phone). A partner app refers to a rewards app or payment app that is configured to be used by customers (enrolled or not enrolled) of the partner. The partner app allows the customers to save payment methods, accumulates points, and/or receive coupons as he spends at the premises of the partner. The partner app is downloadable from the Google Play Store, Apple App Store, or other similar apps or locations.

The communication (e.g., the in-store message or customized message based on facial recognition) can be configured to be implemented entirely or partly in the partner's app for their customers. For example, a coffee shop can have its own mobile application for rewards or remote purchasing and the message can be generated in that mobile app (using the coffee shops servers) and communicated to the user as a message in that mobile app. The system (e.g., system 140) may also be configured to send a message or notification to the partner (e.g., the coffee shops system for the mobile app) which will trigger the partner's system (e.g., system 105) to send the desired message within the partner's app to the user. This process could use the user's customer account with that partner or rewards number for managing and transmitting the communications.

The partner system 105 authorizes the discount-providing content to be valid within the payment system, e.g., the point-of-sale system located the brick and mortar location of the partner system. When the message received by a user's mobile device on the premise and the user of the mobile device presents the discount-providing content using his mobile device at point-of-sale system such as a check out register as part of a purchasing goods, the point-of-sale system located on the premise is configured to process the content, validated, and in response apply the discount or offer at the point-of-sale terminal to the transaction details. The user of the mobile device can then complete the transaction with the point-of-sale transaction. Other types of content such as gift card (digital) or store credit are also contemplated to be configured by the partner system 105 to be part of such a process.

In addition to providing personalized messages to identified customers in the store through their mobile phones, such messages can also be provided to digital signage, displays (e.g., TVs, touch-screens), kiosks, and other terminals in the store for communicating the discount or coupon to identified customer. Such equipment may include a network interface to communicate with the feature system, partner system, or both to receive such messages. Such equipment may insert the messages into or show such messages along with other general messages (e.g., discount information that applies to everyone in the store, holiday business hours, etc.) and have them rotated in a certain manner. The identified customers may also approach such equipment (e.g., kiosks) and enter their names, telephone numbers, or other identifiers to retrieve such messages. Printers may be provided to print the coupons or the identified customers can request the coupons or additional copies of the coupons be sent to their mobile phone numbers or emails.

Other information about the identified customer can be provided to other devices on the premise that are configured to communicate the partner system 105, the feature system 100, or both. For example, with reference to FIG. 2b, when an enrolled customer is identified to be currently in a store, using a real time process that identifies that individual, the feature system or the partner system is configured to send the other information about the identified customer to a mobile device used by an employee of the partner, such as iPad or a computer system used as a cash register. The feature system or the partner system is configured to send such information in addition to short messages. As discussed above, the other information may include information the individual provided during program enrollment and information the individual agree to provide (e.g., information that can be obtained from the future such as shopping activities and shopping habits). The other information may include the profile of the individual, the shopping history of the individual, contact information (e.g., a telephone number of the individual to receive short messages or discounts, a messaging address for short message messaging, etc.) or other personal information (e.g., related to demographics, preferences, or shopping habits). The other information may include information the feature system accessed (e.g., the information in the database 115) to prepare or select the content to be incorporated in the short message and other information.

The feature system 100 also includes software and/or hardware that implements the identity management and distribution application 145. The identity management and distribution application 145 is configured to receive information from external sources (e.g., partner system 105) including facial identification information. The identity and distribution application 145 can receive information about clients or customers, which in this context can refer to partners that have selected to use the feature system and the information that is provided can include information about the individual that are enrolled in the program with that partner, watchlists (information about individuals that are on watchlists, such as people who have tendency of spending more than $100 each time, people have stolen items in the past, etc.), and employees (information about the employees of partners such as the facial identification information of those employees).

The short message service vendor system or the vendor system 120 can include both the match and visitor event broker application 155 and the short message service application 160, which is an application that prepares and transmits short messages based on instructions and information provided to it via APIs (e.g., from APIs 150) such as the mobile telephone number of an individual or an application implemented on the feature system 100 configured to provide such instructions and information. The match and visitor event broker application 155 can be hardware and/or software that is configured to selectively determine a communication channel (e.g., 1.4 MHz, 3 MHz, 5 MHz, etc.) depending on the situation and cause a corresponding communication (e.g., notification, alarm, short message, etc.) to be sent via that communication channel, which as shown includes in-app notification, alarm in VMS, collaboration, and short messaging system (labeled SMS, MMS, RCS). The vendor system 120 can transmit short messages and can be configured to have communications with the partner system that is used to receive content that is transmitted by the vendor system 110. The content can be words, images, video, links, QR codes, or other content that is prepared or selected by a partner system 110. The feature system 100 can cooperatively communicate with the vendor system 120 and the partner system 110 to initiate or trigger the short message (and content) to be sent to the mobile phone of the individual identified by the feature system 100, wherein the message is transmitted over a carrier network (e.g., with or without relying on local network at the store premises and transmitted from a remote facility separate from the store premises).

The vendor system 120 may be a separate system configured and maintained by a vendor (e.g., Ytel and 3CInteractive) or built into the feature system 100 or the partner system 105. Such a vendor and vendor system are also known as a message service vendor and a message service vendor system, a message service provider and a message service provider system, a text message marketing service provider and a text message marketing service provider system, or a message service gateway provider and a message service gateway provider system. In one embodiment, such a vendor, provider, or system is a short message service vendor, provider, or system. The vendor system 120 uses at least the carrier network to transmit and receive short messages. The vendor or the vendor system is an entity or system that is separate from the carrier or carrier's system (not controlled by the carrier).

With reference now to FIG. 3, cloud service (e.g., using one or more data centers) can include and implement a face recognition system 310 (that implements facial recognition application 130 in FIG. 1) as part of the feature system. Much of the information in the diagram will be understood by those of ordinary skill in the art. The system 310 is configured to have a core 315 that is a central server or repository for information about facial identification from partners. The core 315 may also store the other information about the enrolled customers. The core 315 communicates with nexus servers 320 to provide such information. The nexus servers 320 can be configured to receive images of enrolled customers 325 and perform the facial recognition process and related actions or process (such as send a communication message to a partner system to start the process to send a short message customized for an enrolled individual). There can be many nexus servers 320 as compared to the core server or repository 315 so as to allow the nexus servers 320 to be responsible for the facial recognition process and the core 315 to, for example, maintain a current (up to date) database of facial identification information. In addition to the watchlist database, each of the core and nexus servers can also include a customers database and an employees database such as those shown in FIG. 2.

In some embodiments, the face recognition system or application can be implemented on a server, a IoT device, or another system shown in FIG. 1 (e.g., feature system, provider system, or client system). The face recognition system or application can also be implemented on a camera (e.g., 118a-118n) or on a mobile phone of an individual. A combination thereof is also contemplated.

As shown, stores can include various components for supporting and working with the feature system. As shown, the system 310 can send email messages, alerts, or short messages (identified as MMS) 330 to the store including to individuals at the store that have been identified to be currently at the store and enrolled in the corresponding program by that partner. As discussed, in some embodiments, a vendor system performs such transmissions (and related communications).

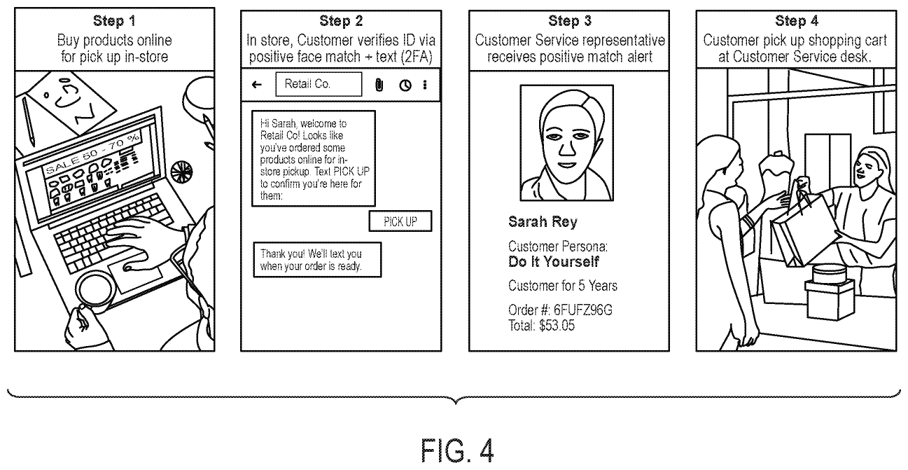

The systems and methods described in this application are also applicable to in-store pick up scenarios and in-store payment scenarios. FIG. 4 depicts an illustrative application to in-store pick up scenario. An enrolled individual makes a purchase online for in-store pick up (step 1). When the individual enters or is in the store to obtain the item he bought, the camera in the store records an image of the individual and the image is transmitted to the feature system. After the feature system determines that the received image has a match in the facial identification information and that the matched individual has made a purchase online for in-store pickup (by communicating with the partner system), the feature system or the feature system in combination with the partner system and vendor system sends a short message to the mobile phone of the individual asking him to confirm that he is here for in-store pickup (step 2). Once the individual responds, the feature system can send additional messages to communicate the status of his order (e.g., whether the item is ready for pickup, will notify the individual when it is ready for pickup, etc.). In addition to sending short messages to the mobile phone of the individual, the feature system can also send other information about the individual to a mobile device used by an employee of the partner for purposes such as asking the employee to retrieve the purchased item from the inventory, if it is already retrieved, tell the employee to be ready as the individual can come to the service desk to pick up at any moment, or recommending other products, extended warranty, or services to the individual (step 3). When the feature system conveys to the individual that his item is ready for pick up, the individual can go to the service desk to pick up his item (step 4). The feature system can be configured to deactivate the pick up short message functionality automatically when the item is scanned for pick up. The pick up short message functionality can also be deactivated by the employee from the employee's mobile device after the pickup (the device showing other information about the individual in step 3).

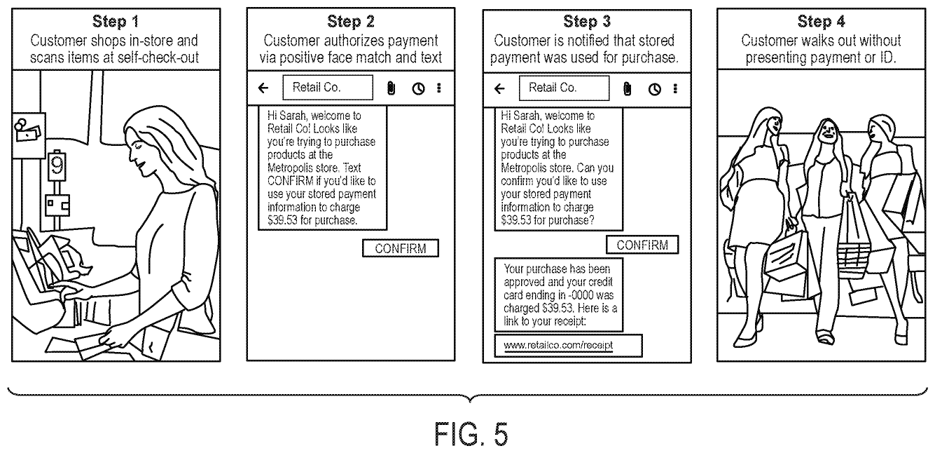

FIG. 5 depicts an illustrative application to in-store payment scenario. An enrolled individual shops in the store and has the items scanned at a checkout register or computer system (step 1). The scan can be performed by the individual himself at a self-checkout register or an employee of the partner at an employee-controlled register. The self-checkout register, the employee, the employee's register, or the individual's mobile phone can ask the individual whether he would like to pay by face match (step 2). After the individual responds affirmatively, the stored payment method linked to the face match is used to make the purchase. The stored payment method may be provided by the individual when he enrolls in the partner's program. The feature system can send additional messages to communicate whether his payment method went through successfully and the receipt of the transaction. This process can involve cameras installed at or in close proximity to the checkout register (point of sale terminal) and/or other cameras such as surveillance security cameras distributed throughout the premise/location such as the surveillance security cameras mounted on or attached to the roof of premises (and related system).

Similar concepts are also applicable to prescription ordering and refilling. In either of the above applications or other applications, when the individual is in the store, the feature system can also send personalized short messages, discounts, or coupons to the mobile phone of the individual before or after (e.g., immediate or a few minutes before or after) the individual picks up or pays for the item.

The described embodiments are configured to involve short messages. As mentioned and understood, short message involve the use of telecommunications messages, a particular type of transmission according to a corresponding transmission structure and protocol over a carrier network. Other types of messages or messaging are also contemplated and applicable such as e-mail or a native app (like a retail stores app, Whatsapp, Facebook Messenger, notification, Google chat, WeChat, etc.). Some of these are in the category of chat applications in which the application is configured to include an interface for a user to engage in chat type communications via a message entry area for typing or inputting a message (e.g., QWERTY keyboard) and an adjacent chat message display area that shows the sequence of messages (back and forth) between the user and other(s) (typically involving a sequence of chat bubbles). The vendor system, feature system, and/or partner system may be configured to support and operate (create and send) such messages to a telephone number or address as part of providing features consistent with those described involving short messages.

In addition to telephone number, other addresses and sequence of digits, characters, symbols, or a combination thereof may also be used to communicate the customized messages to the mobile phone of the identified individual. For example, use usernames, messenger IDs, account numbers, profiles, loyalty numbers, and membership IDs may also be used. For instance, a customer of a partner could have an account with the partner and have the partner's app installed on his mobile phone. The message could be sent to the customer via the partner's app by using the customer's partner account number.

Images for facial recognition can be provided from cameras on the premises of the client such as positioned at or near the entrances. Cameras can be surveillance security cameras that may already exist on the premises and are distributed throughout the facility to monitor for theft for example. Video from such cameras can be used in the facial recognition process.

As generally described herein, the client system 105 and/or feature system 100 can be configured to store information about the facial features (e.g., a picture) of a customer that the customer provided by sending a message containing a facial image or authorizing an image or video of that customer (e.g., the image is obtained and stored in real-time when an enrolled customer enters one of the partner's premises for the first time after enrollment, as opposed to pre-recording and pre-storing an image during the enrollment process). The information is obtained and/or stored in response to the customer's authorization by action such as sending a message, taking a picture, or responding to a selectable option at a user interface such as a user interface of the program creation and enrollment application. By such a process, interactive process involving the customer, a database is filled with such information of the enrolled customers and the database indicates that the information is authorized by the customer by being in the database and accessible and/or by specific data fields specifying privacy selection of that customer (e.g., selected via a user interface). This, for example, is different and/or as a higher level of accuracy compared to systems that are identifying individuals based on facial recognition for security purposes such as when the information is provided or collected from government sources that may have collected the information using surveillance.

It is understood from the above description that the functionality and features of the systems, devices, or methods of embodiments of the present invention include generating and sending signals to accomplish the actions.

Each of the feature system, partner computer system, vendor system, and other system and server mentioned in this application can be implemented on one or more computer systems and be configured to communicate over a network. They all may also be implemented on one single computer system. A computer system includes a bus or other communication mechanism for communicating information, a processor coupled with the bus for processing information a memory coupled to the bus for storing information and instructions to be executed by the processor, a network interface allowing the computer system to communicate over the network, and other components. A computer system may be a desktop computer, laptop computer, or other computer system having a processor and memory. In some embodiments, a computer system may be a tablet computer, a cellular device, a smartphone, a personal digital assistant (PDA), or other mobile device having a processor and memory. Each of the feature system, partner computer system, vendor system, and other system and server includes software involving computer readable instructions that implement operation and capabilities illustratively described herein. Computer readable instructions are stored in the memory (e.g., non-transitory/non-volatile memory) and are executable by the processor.

The processor may include an application specific integrated circuit (ASIC), programmable logic array (PLA), digital signal processor (DSP), field programmable gate array (FPGA), or any other integrated circuit. The processor can also include one or more of any other applicable processors, such as a system-on-a-chip that combines one or more of a CPU, an application processor, and memory, or a reduced instruction set computing (RISC) processor.

The memory may include cache memory, semi-permanent memory such as RAM, and/or one or more types of memory used for temporarily storing data. The memory is preferably a volatile media but it may also be a non-volatile media.

The computer system may also include a storage device and/or another memory device. The storage device may include a hard disk drive and/or a removable storage drive, representing a floppy disk drive, a magnetic tape drive, an optical disk drive, etc. The storage device is preferably a non-volatile media but it may also be or include a volatile media. The removable storage drive reads from and/or writes to a removable storage unit in a well-known manner. As will be appreciated, the removable storage unit includes a computer usable storage medium having stored therein computer software, data, and/or instructions.

The other memory device may include other similar devices for allowing computer programs or other instructions to be loaded into the computer system. Such devices may include, for example, a removable storage unit and an interface. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from the removable storage unit to the computer system.

A network may be Internet, a cellular network, a telephone network, a computer network, a packet switching network, a line switching network, a local area network (LAN), a wide area network (WAN), a global area network, or any number of private networks currently referred to as an Intranet, and/or any other network or combination of networks that can accommodate data communication. A network may be a communications network using any suitable communications protocol such as Wi-Fi, 802.11, Bluetooth, radio frequency systems such as 900 MHz, 1.4 GHz, and 5.6 GHz communication systems, infrared, GSM, GSM plus EDGE, CDMA, quadband, and other cellular protocols, VOIP, or any other suitable protocol. The network may also be established by using wires such as an optical fiber or Ethernet cable.

A network interface may be a hardware device configured to support the above communications protocol such as integrated services digital network (ISDN) card, local area network (LAN) card, Ethernet card, cable modem, satellite modem, or a modem to provide a data communication connection to a corresponding type of telephone line.

The computer system of the feature system, partner system, vendor system, and other system and server may be implemented as a server computer system. Server computer system means a communication-oriented computer; usually with faster processor, larger memory, larger storage capacity, and general capability of sustaining concurrent data communication with multiple end users or client devices.

The database mentioned in this application may be implement using one or more the memory, storage device, and memory device discussed above. The database may be implemented as part of the feature system, partner system, and/or vendor system, or as a separate system from the feature system, partner system, and/or vendor system. The database may include non-volatile media and/or volatile media.

It should be understood that variations, clarifications, or modifications are contemplated. Applications of the technology to other fields are also contemplated.

Exemplary systems, devices, and methods are described for illustrative purposes. Further, since numerous modifications and changes will readily be apparent to those having ordinary skill in the art, it is not desired to limit the invention to the exact constructions as demonstrated in this disclosure. Accordingly, all suitable modifications and equivalents may be resorted to falling within the scope of the invention.

Thus, for example, any sequence(s) and/or temporal order of steps of various processes or methods (or sequence of device connections or operation) that are described herein are illustrative and should not be interpreted as being restrictive. Accordingly, it should be understood that although steps of various processes or methods or connections or sequence of operations may be shown and described as being in a sequence or temporal order, but they are not necessarily limited to being carried out in any particular sequence or order. For example, the steps in such processes or methods generally may be carried out in various different sequences and orders, while still falling within the scope of the present invention. Moreover, in some discussions, it would be evident to those of ordinary skill in the art that a subsequent action, process, or feature is in response to an earlier action, process, or feature.

It is also implicit and understood that the applications or systems illustratively described herein provide computer-implemented functionality that automatically performs a process or process steps unless the description explicitly describes or would primarily be understood to involve user intervention or manual operation (e.g., determining nest configuration in a drawer is automatically performed by the cabinet, detecting a broken pattern is automatically performed by the cabinet, etc.). It should be understood that claims that include fewer limitations, broader claims, such as claims without requiring a certain feature or process step in the appended claim or in the specification, clarifications to the claim elements, different combinations, and alternative implementations based on the specification, or different uses, are also contemplated by the embodiments of the present invention.

The words “can” or “may” are used to communicate or clarify that this is one option and others options or variations are contemplated. This is not to say that if such a word is not used, it is being communicated that this only implementation.

It should be understood that combinations of described features or steps are contemplated even if they are not described directly together or not in the same context.

The terms or words that are used herein are directed to those of ordinary skill in the art in this field of technology and the meaning of those terms or words will be understood from terminology used in that field or can be reasonably interpreted based on the plain English meaning of the words in conjunction with knowledge in this field of technology.

It is intended that the specification and examples be considered as exemplary only, with a true scope being indicated by the claims and their equivalents.

What is claimed is:

1. A computer-implemented method comprising:
implementing a program application for an entity allowing the entity to create a program through which the entity can receive identification information and other personal information of one or more individuals and transmit customized messages to the individuals when the individuals are on a physical premise of the entity;
receiving identification information and other personal information of one or more persons through the implemented program application, wherein the identification information includes facial identification information of each person and a telephone number of each person associated with a mobile device, wherein the identification information and other personal information are provided by the persons specifically for the program to receive customized messages from the entity when they are on a physical premise of the entity;
receiving one or more frames from video cameras positioned in physical premises of the entity;
applying a facial recognition process to the received frames based on a database storing the facial identification information of the individuals in the program, wherein the step of applying determines that a person in the program is currently in one of the physical premises of the entity and identifies the person;
generating a customized message using the received other personal information for the identified person; and
transmitting the customized message to a mobile phone of the identified person over one or more mobile cellular wireless telecommunications network using the telephone number received for the program, wherein the customized message is received by the identified person while he is on the premise of the entity.

2. The method of claim 1, wherein the customized message is transmitted to the mobile phone of the identified person within 1-5 minutes after receiving the one or more frames from the video cameras.

3. The method of claim 1, further comprising generating and transmitting additional messages in response to the identified person responding to the transmitted customized message.

4. The method of claim 1, wherein the transmitted customized message or additional messages includes a coupon code that can be redeemed at a cash register of the physical premise of the entity.

5. The method of claim 1, further comprising retrieving content from a database of marketing materials or a system that is configured to generate marking content based on information in the program or received identification information and other personal information that provide context such as a shopping history of the person with the entity.

6. The method of claim 1, further comprising instructing a separate third party system to generate and transmit the customized message to the mobile phone of identified person.

7. The method of claim 1, further comprising communicating with an enterprise system of the entity and a short message service provider system to initiate the transmission of the customized message.

8. The method of claim 1, further comprising communicating with an enterprise system of the entity and a short message service provider system to coordinate the two systems to cause the transmission of the customized message.

9. The method of claim 1, further comprising generating and transmitting other information about the identified person to a mobile device used by an employee of the entity.

10. The method of claim 1, wherein the step of receiving one or more frames from video cameras positioned in physical premises of the entity include receiving one or more frames from surveillance security cameras positioned in physical premises of the entity.

11. The method of claim 1, further comprising determining that the identified person made a purchase online for in-store pickup and the step of transmitting the customized message includes transmitting a customized message asking the identified person to confirm that he is on the premise for in-store pickup.

12. The method of claim 11, further comprising generating and transmitting other information about the identified person made a purchase online for in-store pickup to a mobile device used by an employee of the entity.

13. The method of claim 1, wherein the other personal information the identified person provided for the program includes payment method information and the step of transmitting the customized message includes transmitting a customized message asking the identified person whether a transaction on the premise should be processed using the payment method information.

14. The method of claim 13, further comprising transmitting another customized message including a receipt of the transaction.

15. The method of claim 1, further comprising transmitting the received frames to a data center implementing a facial recognition process that is remote from the physical premises in which the video cameras are positioned and the step of applying a facial recognition process is performed at the data center.

16. The method of claim 1, further comprising receiving a response to the transmitted customized message from the mobile phone of the identified person over the mobile cellular wireless telecommunications network.

17. The method of claim 1, wherein the facial identification information includes an image of each person.

18. The method of claim 17, further comprising receiving the image from a mobile device of that person.

19. A non-transitory computer readable medium storing computer-executable instructions that cause a computer system to execute a method, the method comprising:
implementing a program application for an entity allowing the entity to create a program through which the entity can receive identification information and other personal information of one or more individuals and transmit customized messages to the individuals when the individuals are on a physical premise of the entity;
receiving identification information and other personal information of one or more persons through the implemented program application, wherein the identification information includes facial identification information of each person and a telephone number of each person associated with a mobile device, wherein the identification information and other personal information are provided by the persons specifically for the program to receive customized messages from the entity when they are on a physical premise of the entity;
receiving one or more frames from video cameras positioned in physical premises of the entity;
applying a facial recognition process to the received frames based on a database storing the facial identification information of the individuals in the program, wherein the step of applying determines that a person in the program is currently in one of the physical premises of the entity and identifies the person;
generating a customized message using the received other personal information for the identified person; and
transmitting the customized message to a mobile phone of the identified person over one or more mobile cellular wireless telecommunications network using the telephone number received for the program, wherein the customized message is received by the identified person while he is on the premise of the entity.

20. A computer-implemented system comprising:
a feature system including a processor and memory that stores computer-executable instructions, wherein execution of the instructions causes the processor to:
implement a program application that is configured to allow an entity to create a program through which the entity can receive identification information and other personal information of one or more individuals and transmit customized messages to the individuals when the individuals are on a physical premise of the entity;
receive identification information and other personal information of one or more persons through the implemented program application, wherein the identification information includes facial identification information of each person and a telephone number of each person associated with a mobile device, wherein the identification information and other personal information are provided by the persons specifically for the program to receive customized messages from the entity when they are on a physical premise of the entity;
receive one or more frames from video cameras positioned in physical premises of the entity;
apply a facial recognition process to the received frames based on a database storing the facial identification information of the individuals in the program, wherein the step of applying determines that a person in the program is currently in one of the physical premises of the entity and identifies the person;
generate a customized message using the received other personal information for the identified person;
communicate with a message service provider system to transmit the generated customized message; and
transmit the customized message using the message service provider system to a mobile phone of the identified person over one or more mobile cellular wireless telecommunications network, wherein the step of transmitting uses the telephone number received for the program to transmit the customized message and the customized message is received by the identified person while he is on the premise of the entity.
